(19) United States
(12) Patent Application Publication
(10) Pub. No.: US 2026/0245420 A1
(43) Pub. Date: Aug. 20, 2026

(54) RATCHETING SHUTTER FLANGE

(71) Applicant: Cardtronics USA, Inc., Atlanta, GA (US)

(72) Inventor: Maxwell Alfred Wiewiorka, Invergowrie (GB)

(21) Appl. No.: 19/053,950

(22) Filed: Feb. 14, 2025

(51) Int. Cl. G07D 11/225; G07D 11/14; G07D 11/40

(52) U.S. Cl. CPC G07D 11/225; G07D 11/14; G07D 11/40

(57) ABSTRACT

A system may be used for manipulating a shutter via a ratcheting shutter flange. An example system may include a first flange including a first set of ratcheting teeth, the first flange mechanically engaged with a shutter such that when the first flange rotates, the shutter rotates and a second flange including a second set of ratcheting teeth configured to mesh with and engage the first set of ratcheting teeth on the first flange. In the example system when a motor is activated to cause the second set of ratcheting teeth of the second flange to engage with the first set of ratcheting teeth of the first flange, the first flange, the second flange, and the shutter may rotate together. In the example system when the shutter is forcibly rotated directly, the first flange may be configured to ratchet with respect to the second flange without moving the second flange.

### BACKGROUND

An Automated Teller Machine (ATM) is an electronic banking device that allows customers to perform financial transactions, such as withdrawing cash, checking account balances, and making deposits, without the need for a human bank teller. ATMs are typically connected to financial networks and are commonly located at bank branches, shopping centers, and other convenient public locations to provide easy access to banking services.

### SUMMARY

In various examples, methods and systems for using a ratcheting shutter flange are presented.

According to an example, a ratcheting shutter flange system may include a first flange including a first set of ratcheting teeth, the first flange mechanically engaged with a shutter such that when the first flange rotates, the shutter rotates and a second flange including a second set of ratcheting teeth configured to mesh with and engage the first set of ratcheting teeth on the first flange. In the example system when a motor is activated to cause the second set of ratcheting teeth of the second flange to engage with the first set of ratcheting teeth of the first flange, the first flange, the second flange, and the shutter may rotate together. In the example system when the shutter is forcibly rotated directly, the first flange may be configured to ratchet with respect to the second flange without moving the second flange.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 illustrates a set of components of an automated teller machine (ATM) in accordance with some examples.

FIG. 2 illustrates two views of a first flange in accordance with some examples.

FIG. 3 illustrates two views of a second flange in accordance with some examples.

FIG. 4 illustrates an exploded view of a ratcheting flange system in accordance with some examples.

FIG. 5 illustrates a ratcheting flange system in multiple states in accordance with some examples.

FIG. 6 illustrates a block diagram illustrating ratcheting in accordance with some examples.

### DETAILED DESCRIPTION

The systems and techniques described herein provide a ratcheting shutter flange to control a shutter of a machine (e.g., a shutter covering a media port of an automated teller machine (ATM)). The ratcheting shutter flange may be used to open the shutter, close the shutter, etc. The ratcheting shutter flange may ratchet with respect to a second ratcheting flange when a force is applied directly to the shutter (e.g., not controlled by the ratcheting shutter flange). For example, a forced entry to the shutter by an attacker may cause the ratcheting shutter flange to ratchet with respect to the second ratcheting flange. In some examples, when the ratcheting shutter flange is ratcheted with respect to the second ratcheting flange, the machine may be disabled (e.g., a transaction may be canceled, the machine may be put in an inoperable or off state, etc.). The ratcheting shutter flange may be detected as ratcheted with respect to the second ratcheting flange using a sensor (e.g., an optical sensor). The ratcheting shutter flange may be reset (e.g., by a technician) after an attack on the shutter, for example without replacing any components of the machine.

Typically, media transfer machines with a shutter do not detect when a shutter blade or a side flange has been broken or removed. By relying on this lack of capability, vandals may access behind the shutter without detection, leaving the unit vulnerable to reverse transaction fraud, placement of cash traps, skimming devices, or other fraudulent devices or activities. A location of metalwork below the shutter on a fascia allows for an easy lever point for shutter attacks, meaning vandals may apply a very large force to the shutter blade quickly with simple tools like a flathead screwdriver or a claw hammer.

Increasing the strength of the shutter blade and shutter assembly components may not resolve the issue of a forced shutter since the force from a vandal attack would transfer through to the fascia, tearing the shutter assembly from the fascia itself, again allowing access behind the shutter. The systems described herein use a specified tamper force to control the flange when the shutter is being forced open by a vandal. The ratcheting shutter flange may be part of a ratcheting system under compression. A specified force may be set at which the ratcheting shutter flange begins to ratchet. The specified force may be set below that of a shutter blade failure force to protect the shutter blade from damage. By allowing the ratcheting shutter flange to rotate relative to the second flange at the specified force, a sensor may be used to detect movement of the ratcheting shutter flange, outside of regular operation. When this is detected to have occurred, the machine may be disabled or put in an out of service mode.

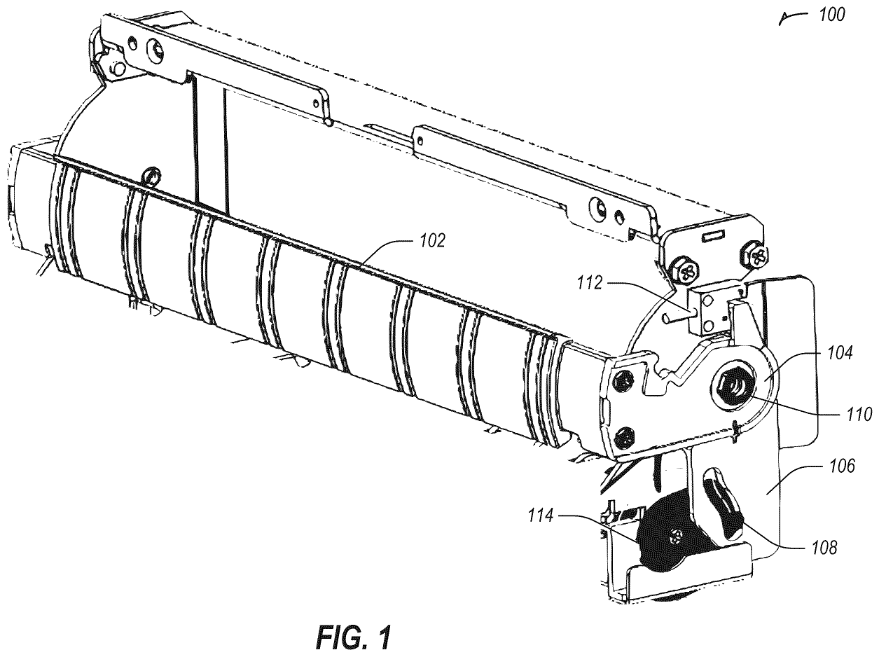

FIG. 1 illustrates a set of components of an automated teller machine (ATM) 100 in accordance with some examples. The ATM 100 includes a shutter 102, a first flange 104, a second flange 106, and a third flange 114. The shutter 102 controls access to a media aperture of the ATM 100. The shutter 102 is configured to open to receive or dispense media. The shutter 102 includes a mechanical engagement with the first flange 104 such that when the first flange 104 rotates, the shutter 102 rotates.

The ATM includes a hex nut 110 and optionally an optical sensor 112. The first flange 104 includes a first set of ratcheting teeth and shown is on a first side of the ATM 100 as an outer flange, which when moved may trigger the optical sensor 112. The second flange 106 is inward of the first flange 104 and interfaces with the first flange 104 via a second set of ratcheting teeth and includes a slot configured to receive a knob 108 of the third flange 114, which is an inward flange from the second flange 106. In an example, opening of the shutter 102 may be controlled by a motor, such as a motor to drive the third flange 114, causing the knob 108 to move and rotate the second flange 106. Rotation of the second flange 106 may cause rotation of the first flange 104, which may be attached to the shutter 102 and cause the shutter to rotate 102 (e.g., open).

The flanges 104 and 106 may be used on either side of the shutter 102 or both sides. In some examples, the optical sensor 112 is located on only one side of the shutter 102, while in other examples two optical sensors are used, for example one on each side of the shutter 102. The first set of ratcheting teeth of the first flange 104 and the second set of ratcheting teeth of the second flange 106 may be unidirectional teeth. The unidirectional teeth provide for transfer of force when the second flange 106 applies a force on the first flange 104. The unidirectional teeth provide for ratcheting (e.g., rotation of the first flange 104 with respect to the second flange 106) when a force is applied on the shutter 102.

The ratcheting shutter side flanges 104 and 106 form a two-part assembly for use on either side of the shutter 102. During assembly (or to reset after a forced entry on the shutter 102), the flanges may be aligned using a marking on each flange 104 and 106. The flange 104 may be mounted on the shutter 102 (e.g., screwed to the shutter 102), such as by being mounted onto a pin on a frame of the shutter 102.

The hex nut 110 may be used to secure the first flange 104 to the second flange 106 (e.g., such that a force by the second set of ratcheting teeth of the second flange 106 causes the first flange 104 to move with the second flange 106). The hex nut 110 may be tightened to prevent the first flange 104 from slipping when a force is applied on the first flange 104 by the second flange 106. Further details about the hex nut 110 and assembly of the hex nut 110 with the first flange 104 and the second flange 106 are described below.

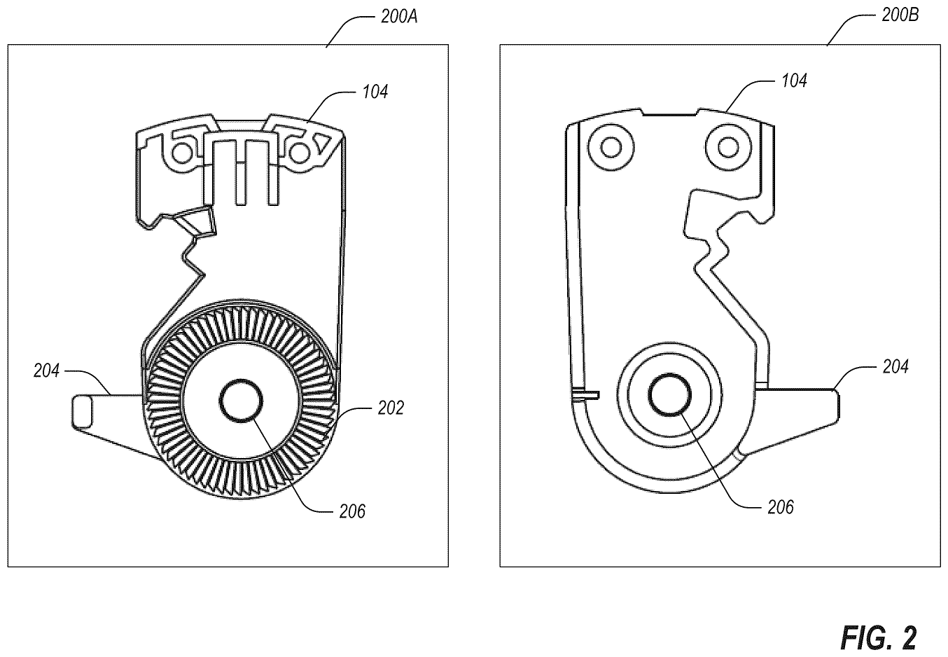

FIG. 2 illustrates two views 200A and 200B of the first flange 104 in accordance with some examples. The first view 200A shows a first side of the first flange 104 including a set of ratcheting teeth 202. The set of ratcheting teeth 202 are configured to be unidirectional (e.g., rotationally) with respect to ratcheting teeth of the second flange 106. The second view 200B shows a second side, opposite the first side, of the first flange 104. Both views 200A and 200B show a mounting bore 206 and a sensor flag protrusion 204. The first flange 104 is configured to interface with the second flange 106 via the hex nut 110 through the mounting bore 206. The sensor flag protrusion 204 may be used to detect rotation of the first flange 104 (e.g., when the shutter 102 is forced open), such as by the optical sensor 112.

The sensor flag protrusion 204 may be detected by the optical sensor 112 in an idle state of the ATM. When the sensor flag protrusion 204 begins to move out of range of the optical sensor 112, an alert may be output. In some examples, the optical sensor 112 may be disabled when the shutter 102 is caused to open during a transaction, since it may otherwise indicate an alert based on movement of the sensor flag protrusion 204 out of range of the optical sensor 112.

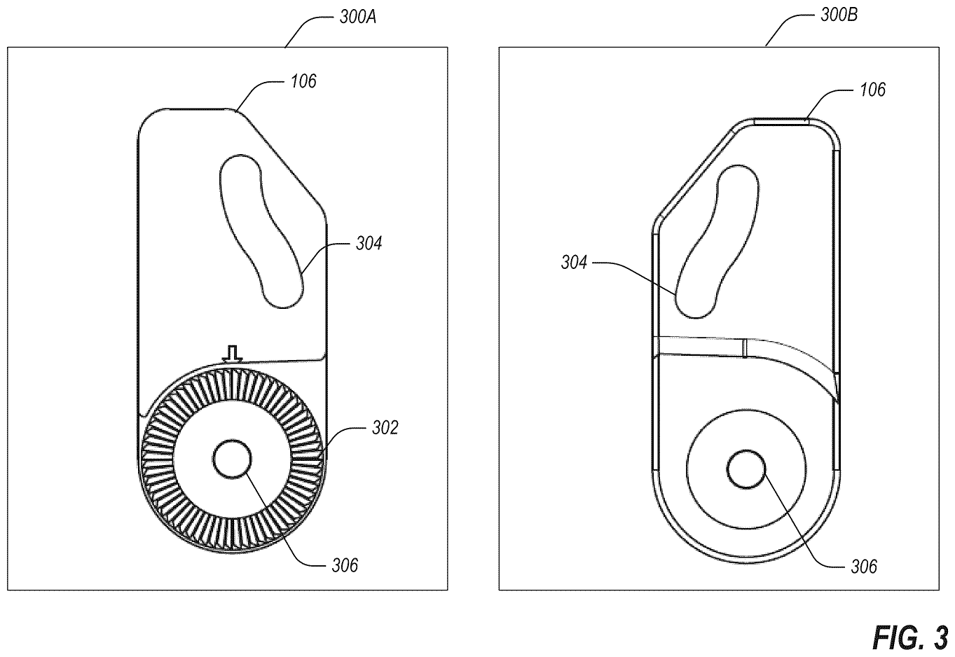

FIG. 3 illustrates two views 300A and 300B of the second flange 106 in accordance with some examples. The first view 300A shows a first side of the second flange 106 including a set of ratcheting teeth 302. The second view 300B shows a second side, opposite the first side, of the second flange 106. Both views 300A and 300B show a mounting bore 306 and a knob receiving bore 304 configured to receive the knob 108 of the third flange 114. The second flange 106 is configured to interface with the first flange 104 via the hex nut 110 through the mounting bore 306. The set of ratcheting teeth 302 are configured to be unidirectional (e.g., rotationally) with respect to the ratcheting teeth 202 of the first flange 104. When the second flange 104 is rotated (e.g., by the knob 108 via the knob receiving bore 304), the ratcheting teeth 302 apply a force on the ratcheting teeth 202 to cause the first flange 104 to rotate with the second flange 106. When a force is applied on the first flange 104 (e.g., by a force on the shutter 102), the ratcheting teeth 302 slip with respect to the ratcheting teeth 202, causing the first flange 104 to rotate with respect to the second flange 106 (e.g., where the second flange 106 is not caused to move).

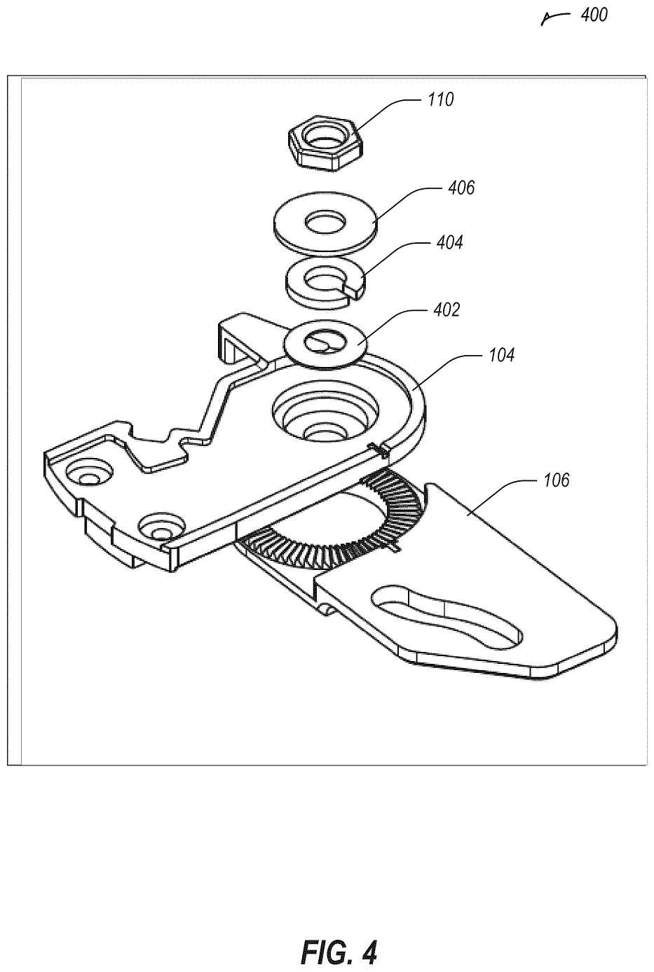

FIG. 4 illustrates an exploded view 400 of a ratcheting flange system in accordance with some examples. The exploded view 400 shows the second flange 106, the first flange, and a set of washers, including a Belleville washer 402, a spring washer 404, a ring washer 406 (e.g., M6, 15.5 mm OD washer), and the hex nut 110 (e.g., a low profile M6 hex nut). The spring washer 404 and the Belleville washer 402 may be fitted over a shaft (not shown), and tightened to the first flange 104 via the hex nut 110. The Belleville washer 402 may be in contact with a shoulder on the first flange 104. The Belleville washer 402 or the spring washer 404 may be compressed by the hex nut 110. The spring washer 404 may be used to generate a friction force between the first flange 104 and the second flange 106. The spring washer 404 may couple the first flange 104 to the second flange 106 allowing the first flange 104 and the second flange 106 to move together during normal shutter operation (e.g., opening or closing of the shutter 102). The Belleville washer 402 acts like a spring under compression (e.g., by the hex nut 110). The compressive force of the Belleville washer 402 may be used with a coefficient of friction between the first flange 104 and the second flange 106 and an angle of the teeth to calculate a force applied to the shutter blade that causes the assembly to ratchet. This force may be varied based on the compressive force or the angle of the teeth. For example, the ratcheting force may be varied such that the first flange 104 ratchets with respect to the second flange 106 across a range of 200 to 400N per side, 400 to 800N combined shutter assembly force.

When a force is applied to the first flange 104, outside of normal operation (e.g., a prying force on the shutter 102), the Belleville washer 402 begins to compress. The compressive force on the Belleville washer 402 may be used to specify a prying force at which the flange assembly (e.g., the first flange 104 and the second flange 106) begin to ratchet. As the respective teeth on each flange 104 and 106 try to move past each other, the Belleville washer 404 compresses. The Belleville washer 402 may be configured to be compressed flat for the teeth to ratchet. As the respective teeth on each flange 104 and 106 clear each other, the Belleville washer 404 returns to a home position (e.g., decompresses), where when further force is applied, the Belleville washer 404 may recompress.

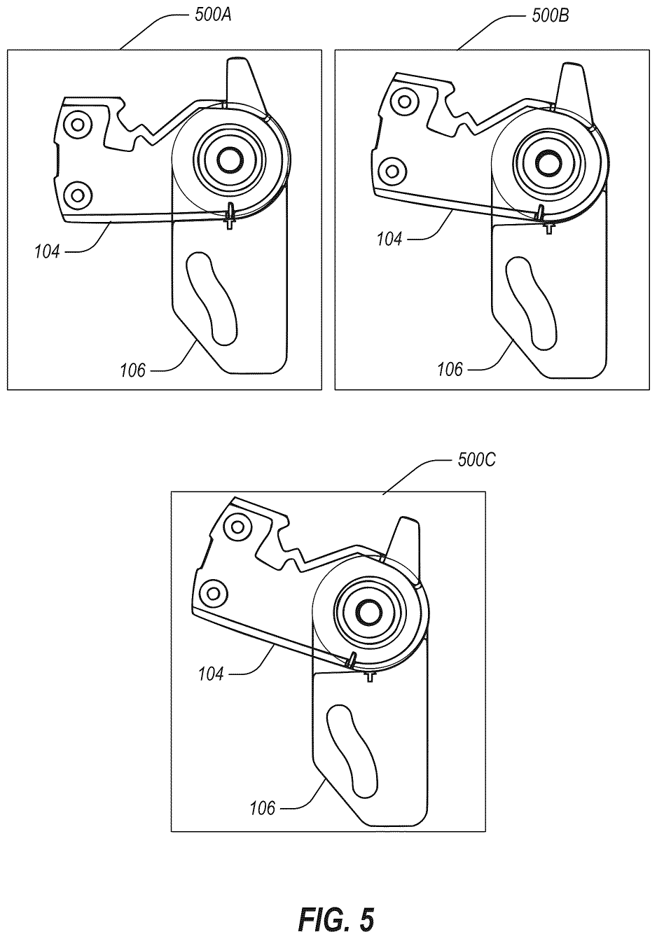

FIG. 5 illustrates a ratcheting flange system in multiple states (e.g., as illustrated in views 500A, 500B, and 500C) in accordance with some examples. View 500A illustrates the first flange 104 and the second flange 106 in a default operational position with respect to each other (e.g., substantially orthogonal to each other). View 500B illustrates the first flange 104 and the second flange 106 after a force has been applied to the first flange 104 (e.g., via a force on the shutter 102) causing the first flange 104 to ratchet with respect to the second flange 106. When the ratcheting flange system is in the state shown in view 500B, it may not be reset to the state in 500A without a service technician opening the ATM and releasing the hex nut 110 to reset the ratcheted flanges. The state in view 500B may trigger an alert in some examples. In other examples, the state in view 500B may not be enough to open the shutter 102, but may indicate that an attempt was made to open the shutter. The ratcheting may cause a person attempting to pry open the shutter 102 to stop, for example after hearing the ratcheting. An alert may be issued, such as an indication sent to an operator of the ATM, an audible, visual, or haptic alert to stop applying a force to the shutter 102, etc.

The state shown in view 500C illustrates a further ratcheting of first flange 104 with respect to the second flange 106. In this state, the ATM may be placed in an inoperable mode (e.g., shut down, put in a safety mode, etc.), such as where the ATM is not usable to withdraw or deposit media.

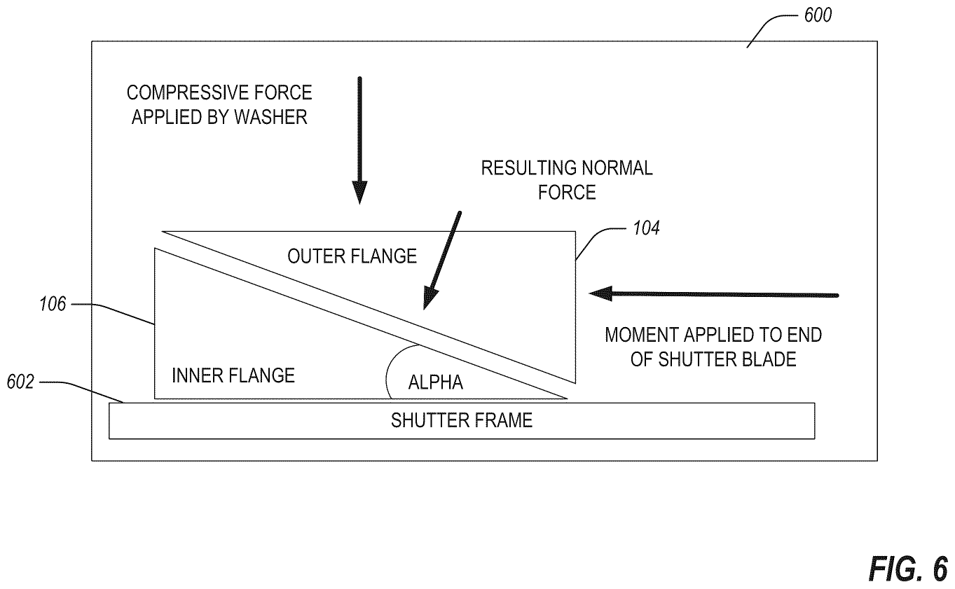

FIG. 6 illustrates a block diagram 600 illustrating ratcheting in accordance with some examples. The block diagram 600 illustrates interaction of forces between the first flange 104, the second flange 106, and a shutter frame 602. A compressive force is applied by a washer on the first flange 104. When a moment is applied to an end of the shutter 102, a normal force results, which is applied on the second flange 106 (and the shutter frame 602 by the second flange 106). A friction force resists the motion of the second flange 106 with respect to the first flange 104. The friction force is equal to a coefficient of friction times the normal force. The coefficient of friction may be a coefficient of friction between a tooth of the first flange 104 and a tooth of the second flange 106. The friction force is independent of surface area of the teeth. Because the normal force is equal to the force applied by the Belleville washer 404 divided by an arccosine of the angle alpha of the second flange 106 (e.g., a tooth of the second flange 106), the normal force may be varied by altering the angle alpha of the teeth of the second flange 106 (or the first flange 104). In other examples, the normal force may be varied by changing the Belleville washer 404 to another spring washer (e.g., with more or less compressive force).

Each of these non-limiting examples may stand on its own, or may be combined in various permutations or combinations with one or more of the other examples.

Example 1 is a ratcheting shutter flange system comprising: a first flange including a first set of ratcheting teeth, the first flange mechanically engaged with a shutter such that when the first flange rotates, the shutter rotates; a second flange including a second set of ratcheting teeth configured to mesh with and engage the first set of ratcheting teeth on the first flange; wherein when a motor is activated to cause the second set of ratcheting teeth of the second flange to engage with the first set of ratcheting teeth of the first flange, the first flange, the second flange, and the shutter rotate together; and wherein when the shutter is forcibly rotated directly, the first flange is configured to ratchet with respect to the second flange without moving the second flange.

In Example 2, the subject matter of Example 1 includes, wherein the ratcheting shutter flange system further includes a spring washer and a nut that compresses the spring washer against a face of the first flange opposite the first set of ratcheting teeth, the nut compressing the first flange to the second flange.

In Example 3, the subject matter of Example 2 includes, wherein the spring washer is a conical spring washer.

In Example 4, the subject matter of Examples 1-3 includes, wherein the shutter is forcibly rotated directly when a force above a threshold is exerted on the shutter.

In Example 5, the subject matter of Examples 1-4 includes, wherein the ratcheting shutter flange system is part of an automated teller machine (ATM) and further comprises processing circuitry and memory, including instructions, which when executed by the processing circuitry, cause the processing circuitry to perform operations comprising: detecting that the shutter has been forcibly rotated directly; and in response, canceling a current transaction at the ATM and disabling the ATM from performing further transactions until reset.

In Example 6, the subject matter of Example 5 includes, wherein the instructions further cause the processing circuitry to perform operations comprising sending a security alert to dispatch a service engineer to the ATM for inspection of the shutter.

In Example 7, the subject matter of Examples 1-6 includes, wherein the ratcheting shutter flange system is part of an automated teller machine, a point-of-sale terminal, or a self-service terminal.

In Example 8, the subject matter of Examples 1-7 includes, wherein the ratcheting shutter flange system is configured to be resettable after the shutter is forcibly rotated directly without replacing the first flange, the second flange, or the shutter.

Example 9 is an automated teller machine (ATM) comprising: a shutter configured to open to receive or dispense media; a first flange including a first set of ratcheting teeth, the first flange mechanically engaged with the shutter such that when the first flange rotates, the shutter rotates; a second flange including a second set of ratcheting teeth configured to mesh with and engage the first set of ratcheting teeth on the first flange; and a motor configured to cause the second set of ratcheting teeth of the second flange to engage with the first set of ratcheting teeth of the first flange to cause the first flange, the second flange, and the shutter to rotate together, wherein when the shutter is forcibly rotated directly, the first flange is configured to ratchet with respect to the second flange without moving the second flange.

In Example 10, the subject matter of Example 9 includes, wherein the ATM further includes a spring washer and a nut that compresses the spring washer against a face of the first flange opposite the first set of ratcheting teeth, the nut compressing the first flange to the second flange.

In Example 11, the subject matter of Example 10 includes, wherein the spring washer is a conical spring washer.

In Example 12, the subject matter of Examples 9-11 includes, wherein the shutter is forcibly rotated directly when a force above a threshold is exerted on the shutter.

In Example 13, the subject matter of Examples 9-12 includes, wherein the ATM further comprises processing circuitry and memory, including instructions, which when executed by the processing circuitry, cause the processing circuitry to perform operations comprising: detecting that the shutter has been forcibly rotated directly; and in response, canceling a current transaction at the ATM and disabling the ATM from performing further transactions until reset.

In Example 14, the subject matter of Example 13 includes, wherein the instructions further cause the processing circuitry to perform operations comprising sending a security alert to dispatch a service engineer to the ATM for inspection of the shutter.

In Example 15, the subject matter of Examples 9-14 includes, wherein the first flange, the second flange, and the shutter are configured to be resettable after the shutter is forcibly rotated directly without replacing the first flange, the second flange, or the shutter.

Example 16 is a ratcheting shutter flange system comprising: a first flange including a first set of ratcheting teeth, the first flange mechanically engaged with a shutter such that when the first flange rotates, the shutter rotates; a second flange including a second set of ratcheting teeth configured to mesh with and engage the first set of ratcheting teeth on the first flange; a conical spring washer and a nut that compresses the conical spring washer against a face of the first flange opposite the first set of ratcheting teeth, the nut compressing the first flange to the second flange; and wherein when a motor is activated to cause the second set of ratcheting teeth of the second flange to engage with the first set of ratcheting teeth of the first flange, the first flange, the second flange, and the shutter rotate together; and wherein when the shutter is forcibly rotated directly, the first flange is configured to ratchet with respect to the second flange without moving the second flange.

In Example 17, the subject matter of Example 16 includes, wherein the shutter is forcibly rotated directly when a force above a threshold is exerted on the shutter.

In Example 18, the subject matter of Examples 16-17 includes, wherein the ratcheting shutter flange system is part of an automated teller machine (ATM) and further comprises processing circuitry and memory, including instructions, which when executed by the processing circuitry, cause the processing circuitry to perform operations comprising: detecting that the shutter has been forcibly rotated directly; and in response, canceling a current transaction at the ATM and disabling the ATM from performing further transactions until reset.

In Example 19, the subject matter of Example 18 includes, wherein the instructions further cause the processing circuitry to perform operations comprising sending a security alert to dispatch a service engineer to the ATM for inspection of the shutter.

In Example 20, the subject matter of Examples 16-19 includes, wherein the ratcheting shutter flange system is configured to be resettable after the shutter is forcibly rotated directly without replacing the first flange, the second flange, or the shutter.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A ratcheting shutter flange system comprising:
a first flange including a first set of ratcheting teeth, the first flange mechanically engaged with a shutter such that when the first flange rotates, the shutter rotates;
a second flange including a second set of ratcheting teeth configured to mesh with and engage the first set of ratcheting teeth on the first flange;
wherein when a motor is activated to cause the second set of ratcheting teeth of the second flange to engage with the first set of ratcheting teeth of the first flange, the first flange, the second flange, and the shutter rotate together; and
wherein when the shutter is forcibly rotated directly, the first flange is configured to ratchet with respect to the second flange without moving the second flange.

2. The ratcheting shutter flange system of claim 1, wherein the ratcheting shutter flange system further includes a spring washer and a nut that compresses the spring washer against a face of the first flange opposite the first set of ratcheting teeth, the nut compressing the first flange to the second flange.

3. The ratcheting shutter flange system of claim 2, wherein the spring washer is a conical spring washer.

4. The ratcheting shutter flange system of claim 1, wherein the shutter is forcibly rotated directly when a force above a threshold is exerted on the shutter.

5. The ratcheting shutter flange system of claim 1, wherein the ratcheting shutter flange system is part of an automated teller machine (ATM) and further comprises processing circuitry and memory, including instructions, which when executed by the processing circuitry, cause the processing circuitry to perform operations comprising:
detecting that the shutter has been forcibly rotated directly; and
in response, canceling a current transaction at the ATM and disabling the ATM from performing further transactions until reset.

6. The ratcheting shutter flange system of claim 5, wherein the instructions further cause the processing circuitry to perform operations comprising sending a security alert to dispatch a service engineer to the ATM for inspection of the shutter.

7. The ratcheting shutter flange system of claim 1, wherein the ratcheting shutter flange system is part of an automated teller machine, a point-of-sale terminal, or a self-service terminal.

8. The ratcheting shutter flange system of claim 1, wherein the ratcheting shutter flange system is configured to be resettable after the shutter is forcibly rotated directly without replacing the first flange, the second flange, or the shutter.

9. An automated teller machine (ATM) comprising:
a shutter configured to open to receive or dispense media;
a first flange including a first set of ratcheting teeth, the first flange mechanically engaged with the shutter such that when the first flange rotates, the shutter rotates;
a second flange including a second set of ratcheting teeth configured to mesh with and engage the first set of ratcheting teeth on the first flange; and
a motor configured to cause the second set of ratcheting teeth of the second flange to engage with the first set of ratcheting teeth of the first flange to cause the first flange, the second flange, and the shutter to rotate together, wherein when the shutter is forcibly rotated directly, the first flange is configured to ratchet with respect to the second flange without moving the second flange.

10. The ATM of claim 9, wherein the ATM further includes a spring washer and a nut that compresses the spring washer against a face of the first flange opposite the first set of ratcheting teeth, the nut compressing the first flange to the second flange.

11. The ATM of claim 10, wherein the spring washer is a conical spring washer.

12. The ATM of claim 9, wherein the shutter is forcibly rotated directly when a force above a threshold is exerted on the shutter.

13. The ATM of claim 9, wherein the ATM further comprises processing circuitry and memory, including instructions, which when executed by the processing circuitry, cause the processing circuitry to perform operations comprising:
detecting that the shutter has been forcibly rotated directly; and
in response, canceling a current transaction at the ATM and disabling the ATM from performing further transactions until reset.

14. The ATM of claim 13, wherein the instructions further cause the processing circuitry to perform operations comprising sending a security alert to dispatch a service engineer to the ATM for inspection of the shutter.

15. The ATM of claim 9, wherein the first flange, the second flange, and the shutter are configured to be resettable after the shutter is forcibly rotated directly without replacing the first flange, the second flange, or the shutter.

16. A ratcheting shutter flange system comprising:
a first flange including a first set of ratcheting teeth, the first flange mechanically engaged with a shutter such that when the first flange rotates, the shutter rotates;
a second flange including a second set of ratcheting teeth configured to mesh with and engage the first set of ratcheting teeth on the first flange;
a conical spring washer and a nut that compresses the conical spring washer against a face of the first flange opposite the first set of ratcheting teeth, the nut compressing the first flange to the second flange; and
wherein when a motor is activated to cause the second set of ratcheting teeth of the second flange to engage with the first set of ratcheting teeth of the first flange, the first flange, the second flange, and the shutter rotate together; and
wherein when the shutter is forcibly rotated directly, the first flange is configured to ratchet with respect to the second flange without moving the second flange.

17. The ratcheting shutter flange system of claim 16, wherein the shutter is forcibly rotated directly when a force above a threshold is exerted on the shutter.

18. The ratcheting shutter flange system of claim 16, wherein the ratcheting shutter flange system is part of an automated teller machine (ATM) and further comprises processing circuitry and memory, including instructions, which when executed by the processing circuitry, cause the processing circuitry to perform operations comprising:
detecting that the shutter has been forcibly rotated directly; and
in response, canceling a current transaction at the ATM and disabling the ATM from performing further transactions until reset.

19. The ratcheting shutter flange system of claim 18, wherein the instructions further cause the processing circuitry to perform operations comprising sending a security alert to dispatch a service engineer to the ATM for inspection of the shutter.

20. The ratcheting shutter flange system of claim 16, wherein the ratcheting shutter flange system is configured to be resettable after the shutter is forcibly rotated directly without replacing the first flange, the second flange, or the shutter.
